(19) United States
(12) Patent Application Publication
(10) Pub. No.: US 2011/0283915 A1
(43) Pub. Date: Nov. 24, 2011

(54) WHEEL IMPACT FORCE REDUCTION SYSTEM AND METHOD FOR A RAIL VEHICLE

(76) Inventors: Ajith Kuttannair Kumar, Lawrence Park, PA (US); Bret Worden, Lawrence Park, PA (US)

(21) Appl. No.: 12/784,838

(22) Filed: May 21, 2010

(51) Int. Cl. B61F 5/30; G06F 19/00

(52) U.S. Cl. 105/218.1; 701/19

(57) ABSTRACT

A wheel impact reduction system for a rail vehicle includes a sensor, a control module, and a force reduction assembly. The sensor detects a discontinuity in a rail that is located upstream of a wheel of the rail vehicle in a direction of travel. The control module is communicatively coupled with the sensor. The control module determines whether to apply a correction force to the wheel based on the discontinuity detected by the sensor. The force reduction assembly is joined to the wheel of the rail vehicle and is communicatively coupled with the control module. The force reduction assembly reduces a wheel impact force imparted on the rail by the wheel by applying the correction force to the wheel.

### BACKGROUND OF THE INVENTION

The subject matter described herein relates generally to rail vehicles.

Some known rail vehicles include one or more powered units and, in certain cases, one or more non-powered trailing units. The powered units supply tractive force to propel the powered units and trailing units along one or more rails of a track. The non-powered trailing units hold passengers and/or hold goods. A “non-powered” unit generally encompasses any rail car without an on-board source of motive power. In some cases, the powered units may be referred to as locomotives and may include one or more traction motors. The traction motors provide the tractive force that propels the rail vehicle.

As the rail vehicle travels along the rails, the wheels of the rail vehicle may encounter discontinuities or near discontinuities in one or more rails. The discontinuities may be gaps in the rail and/or abrupt increases in the height of the rail that are located between adjacent sections of the rail. For example, a discontinuity may occur at an insulated joint of the rail. When the wheels of the rail vehicle strike the discontinuities, the wheel may impart an impact force on the rail. The strength of the impact force may be relatively large and may depend on one or more of the mass of the rail vehicle, the speed of the rail vehicle, the size of the discontinuity, the inertia of the wheel and/or axle, and the like.

In high speed rail vehicles, the impact force received by the rail may have a high frequency component and a low frequency component. For example, the impact force may be represented by a waveform having a higher frequency segment and a lower frequency segment. The high frequency component of the impact force may be referred to as a “P1” force and the low frequency component of the impact force may be referred to as a “P2” force. While the P1 force may cause some damage to the rail and/or roadbed on which the rail is located (such as damage to ties, sleepers, ballasts, and the like), the P2 forces of repeated wheel impacts on the rail may cause more significant damage. For example, the P2 forces may cause the rail to become more disconnected from the ties or sleepers. Disconnections between the rail and the ties or sleepers could cause the rails to move apart from each other and/or separate from the lateral ties interconnecting the rails.

Some known high speed locomotives attempt to reduce the P2 forces imparted on the rails by using frame hung traction motors. For example, the traction motors that rotate the wheels of the rail vehicle in order to propel the rail vehicle may be hung from the frames of bogies in the rail vehicle such that the impact forces of the wheels on the rails are dampened. Frame hung traction motors may lead to a reduction in “unsprung mass,” which is the inertia that is coupled to the wheels. The inertia requires an impact force impulse to be applied by the traction motors in order to accelerate the rail vehicle when the rail surface displaces the wheel at high speeds. But, frame hung traction motors, and the complex, compliant drive train which couples each motor to the axle, may be relatively expensive to design, manufacture, and maintain. Several components or parts of frame hung traction motors may require significant maintenance and may require frequent replacement.

A need exists for a system that reduces impact forces imparted on a rail by wheels of a rail vehicle.

### BRIEF DESCRIPTION OF THE INVENTION

In one embodiment, a wheel impact reduction system for a rail vehicle is provided. The system includes a sensor, a control module, and a force reduction assembly. The sensor detects a discontinuity in a rail that is located upstream of a wheel of the rail vehicle in a direction of travel. The control module is communicatively coupled with the sensor. The control module determines whether to apply a correction force to the wheel based on the discontinuity detected by the sensor. The force reduction assembly is joined to the wheel of the rail vehicle and is communicatively coupled with the control module. The force reduction assembly reduces a wheel impact force imparted on the rail by the wheel by applying the correction force to the wheel

In another embodiment, a method for reducing a wheel impact force imparted by a wheel of a rail vehicle on a rail is provided. The method includes detecting a discontinuity in the rail that is located upstream of the wheel in a direction of travel and communicating an identification of the discontinuity to a force reduction assembly interconnected with the wheel. (In an embodiment, “identification” means information relating thereto.) The method also includes reducing the wheel impact force imparted on the rail by the wheel based on the discontinuity detected by the sensor by applying a correction force to the wheel using the force reduction assembly.

In another embodiment, a tangible and non-transitory computer readable storage medium for a rail vehicle having a sensor and a force reduction assembly joined with a wheel of the rail vehicle is provided. The computer readable storage medium includes instructions to direct the sensor to detect a discontinuity in a rail located upstream from the wheel along a direction of travel of the rail vehicle. The computer readable storage medium also includes instructions to direct the force reduction assembly to reduce a wheel impact force imparted on the rail by the wheel based on the discontinuity detected by the sensor by applying a correction force to the wheel.

### BRIEF DESCRIPTION OF THE DRAWINGS

FIG. 1 is a diagram of a rail vehicle in accordance with one embodiment.

FIG. 2 is an illustration of a vertical discontinuity in the rail shown in FIG. 1 in accordance with one embodiment.

FIG. 3 is an illustration of a longitudinal discontinuity in the rail shown in FIG. 1 in accordance with one embodiment.

FIG. 4 is a representation of wheel impact forces exerted on the rail shown in FIG. 1 in accordance with one embodiment.

FIG. 5 is a diagram of a wheel impact reduction system in accordance with one embodiment.

FIG. 6 is a diagram of a wheel impact reduction system in accordance with another embodiment.

FIG. 7 is a flowchart of a method 700 for reducing wheel impact forces imparted on a rail by a wheel in accordance with one embodiment.

### DETAILED DESCRIPTION OF THE INVENTION

The foregoing summary, as well as the following detailed description of certain embodiments of the present invention, will be better understood when read in conjunction with the appended drawings. To the extent that the figures illustrate diagrams of the functional blocks of various embodiments, the functional blocks are not necessarily indicative of the division between hardware circuitry. Thus, for example, one or more of the functional blocks (for example, processors or memories) may be implemented in a single piece of hardware (for example, a general purpose signal processor, microcontroller, random access memory, hard disk, and the like). Similarly, the programs may be stand alone programs, may be incorporated as subroutines in an operating system, may be functions in an installed software package, and the like. The various embodiments are not limited to the arrangements and instrumentality shown in the drawings.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

It should be noted that although one or more embodiments may be described in connection with powered rail vehicle systems having locomotives with trailing cars, the embodiments described herein are not limited to trains. In particular, one or more embodiments may be implemented in connection with different types of rail vehicles and other vehicles. For example, one or more embodiments may be used in connection with a vehicle that travels on one or more rails, such as single locomotives and railcars, powered ore carts and other mining vehicles, light rail transit vehicles, and the like. Example embodiments of systems and methods for reducing the impact forces that wheels impart on rails are provided. As described below, one or more of these embodiments may reduce relatively low frequency components of impact forces imparted by wheels of a rail vehicle on the rail when the wheels encounter or strike a discontinuity in the rail. At least one technical effect described herein includes a method and system that applies a correction force to one or more wheels of a rail vehicle when a discontinuity in a rail is encountered in order to reduce the impact forces of the wheels on the rail and therefore reduce damage to the rail.

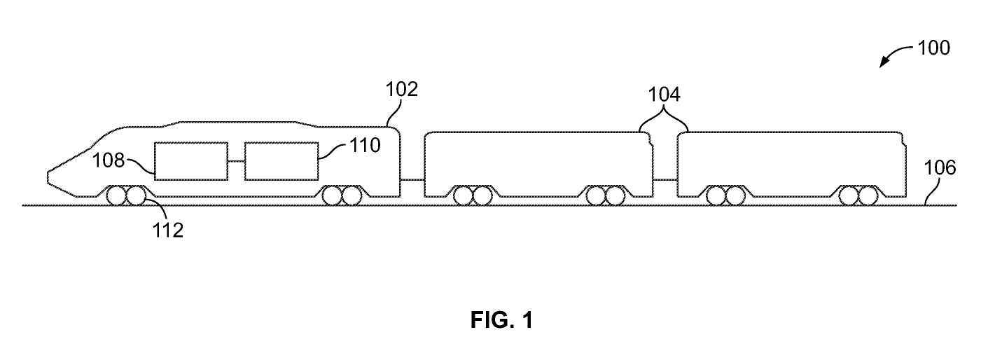

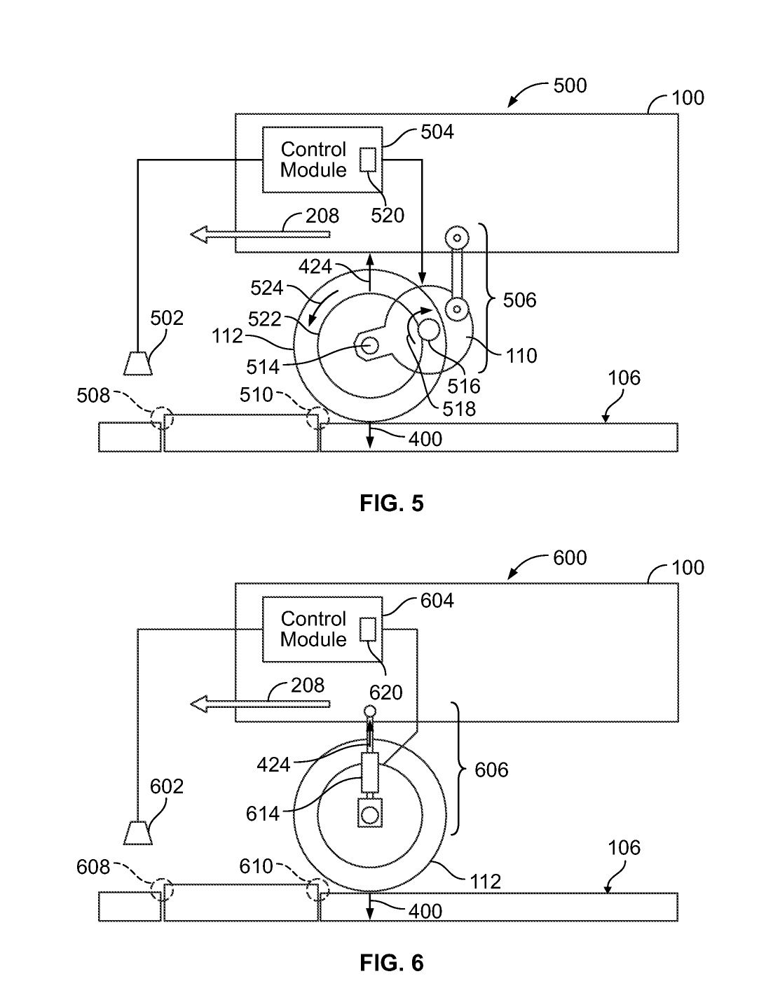

FIG. 1 is a diagram of a rail vehicle 100 in accordance with one embodiment. The rail vehicle 100 includes a lead powered unit 102 coupled with several trailing units 104 that travel along one or more rails 106. In one embodiment, the lead powered unit 102 is a high speed locomotive disposed at the front end of the rail vehicle 100 and the trailing units 104 are passenger cars for carrying passengers and/or storage units for carrying goods along the rails 106. For example, the powered unit 102 may be a locomotive capable of conveying the rail vehicle 100 along the rails 106 at speeds of 125 miles per hour (approximately 200 kph) and greater. (In certain transportation systems, rail vehicle speeds of 200 kph or greater are classified as “high speed.”) Alternatively, the lead powered unit 102 may be located in another position that is not at the front of the rail vehicle 100. The lead powered unit 102 includes an engine 108 that is coupled with one or more traction motors 110. By way of example only, the engine 108 may be an electric, diesel, steam, hydrogen, or gas turbine powered engine, or a hybrid of two or more different types of engines. The engine 108 drives a generator or alternator system, which provides electric current to the traction motor 110. While only one traction motor 110 is shown in FIG. 1, the rail vehicle 100 may include several more traction motors 110 that receive electric current from the engine 108. The traction motor 110 is energized by the engine 108 to propel the rail vehicle 100 along the rails 106. The powered unit 102 and trailing units 104 include wheels 112 that move along the rails 106. The traction motor 110 is schematically shown in FIG. 1 but may be coupled with one or more wheels 112 and/or axles 514 (shown in FIG. 5) of the powered unit 102 to rotate the wheels 112 and/or axles 514 and propel the rail vehicle 100 along the rails 106.

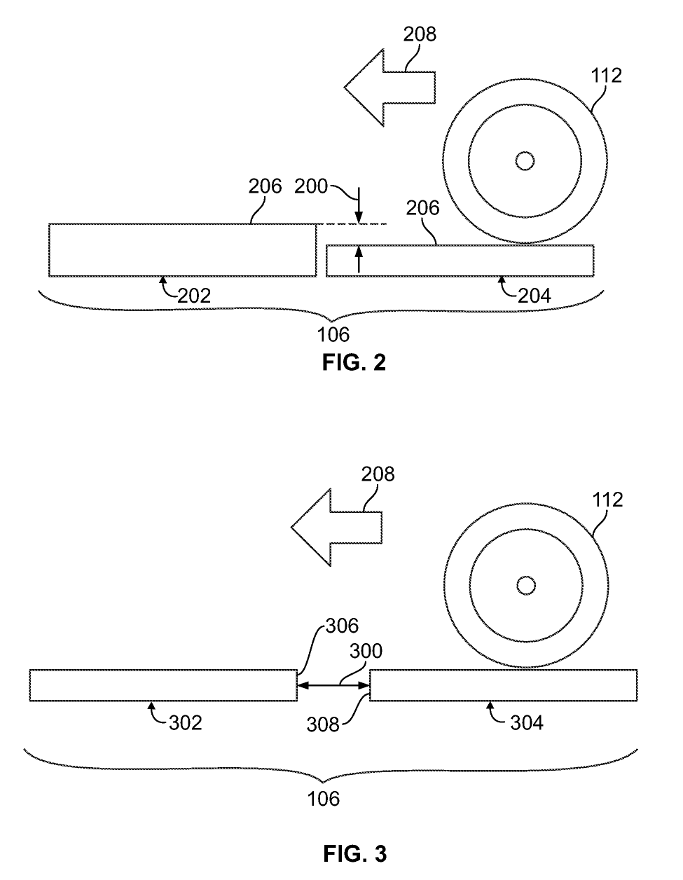

FIG. 2 is an illustration of a vertical discontinuity 200 in the rail 106 in accordance with one embodiment. The rail 106 may be divided into sections 202, 204 along the length of the rail 106. The rail 106 (and each of the sections 202, 204) has an upper surface 206 that the wheels 112 of the rail vehicle 100 (shown in FIG. 1) move along. For example, the wheels 112 of the powered unit 102 (shown in FIG. 1) of the rail vehicle 100 may engage the upper surfaces 206 of the sections 202, 204 to propel the rail vehicle 100 along the rail 106. One or more of the rails 106 may include discontinuities, such as the vertical discontinuity 200. The vertical discontinuity 200 in the rail 106 is a vertical change in the rail 106 that is oriented transverse to a direction of travel 208 of the rail vehicle 100 (shown in FIG. 1) along the rail 106. For example, the vertical discontinuity 200 may be perpendicularly or obliquely oriented with respect to the direction of travel 208.

The vertical discontinuity 200 in the rail 106 represents a relative change or difference between the locations of the upper surfaces 206 of adjacent sections 202, 204 of the rail 106 in one embodiment. For example, as shown in FIG. 2, a vertical discontinuity 200 in the rail 106 may be a difference between the planes in which the upper surfaces 206 of adjacent or neighboring sections 202, 204 of the rail 106 lie. If the upper surfaces 206 of the adjacent sections 202, 204 were coplanar, the vertical discontinuity 200 shown in FIG. 2 would not exist. But, due to wear and tear on the rail 106, settling or movement of the ground below the rails 106, and the like, one or more sections 202, 204 of the rail 106 may vertically move relative to another, neighboring section 202, 204 of the rail 106. The movement of one section 202, 204 relative to another, adjacent section 202, 204 may cause the upper surfaces 206 to no longer be coplanar and for the vertical discontinuity 200 in the rail 106 to be created. While the vertical discontinuity 200 shown in FIG. 2 represents a rise or an increase in the location of the upper surfaces 206 of the sections 202, 204 along the direction of travel 208 of the rail vehicle 100 (shown in FIG. 1), alternatively the vertical discontinuity 200 may be a decrease or dip in the location of the upper surfaces 206 along the direction of travel 208.

FIG. 3 is an illustration of a longitudinal discontinuity 300 in the rail 106 in accordance with one embodiment. The longitudinal discontinuity 300 in the rail 106 is a longitudinal gap or separation in the rail 106 along the direction of travel 208 of the rail vehicle 100 (shown in FIG. 1). For example, each of neighboring or adjacent sections 302, 304 of the rail 106 may have ends 306, 308 that face each other. The longitudinal discontinuity 300 represents a gap or separation between the opposing ends 306, 308 of the rail 106 along the direction of travel 208. If the ends 306, 308 of the adjacent sections 302, 304 abutted one another or were separated by a relatively small gap, the longitudinal discontinuity 300 may not exist.

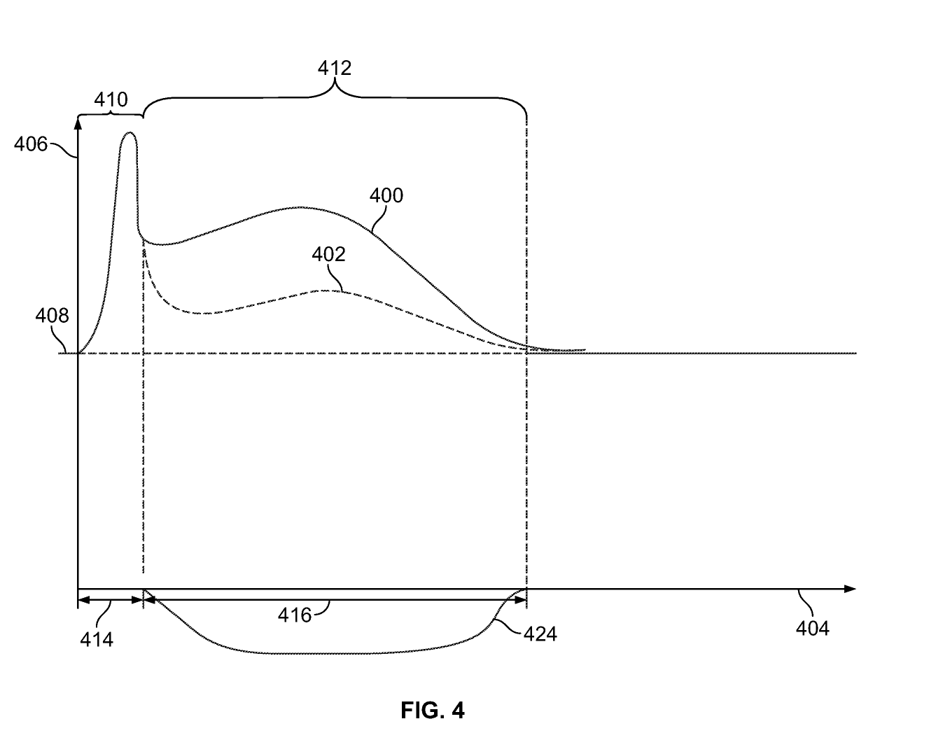

FIG. 4 is a representation of wheel impact forces 400, 402 exerted on the rail 106 (shown in FIG. 1) by the rail vehicle 100 (shown in FIG. 1) in accordance with one embodiment. The wheel impact forces 400, 402 are shown alongside a horizontal axis 404 representative of time and a vertical axis 406 representative of force. The wheel impact force 400 represents the force imparted on the rail 106 by a wheel 112 (shown in FIG. 1) of the rail vehicle 100 (shown in FIG. 1) when the wheel 112 encounters a vertical or longitudinal discontinuity 200, 300 (shown in FIGS. 2 and 3). As described below, the wheel impact force 402 represents the reduced force imparted on the rail 106 by the wheel 112 when the wheel 112 encounters the discontinuity 200, 300 and a wheel impact reduction system 500, 600 (shown in FIGS. 5 and 6) reduces the imparted force by applying a correction force 424.

As the rail vehicle 100 (shown in FIG. 1) moves along the one or more rails 106 (shown in FIG. 1), the wheels 112 (shown in FIG. 1) of the rail vehicle 100 impart a baseline force 408 on the rail 106. The baseline force 408 may be referred to as an inertial reaction force. The baseline force 408 is due in part to the mass of the rail vehicle 100 on the rail 106. When the wheel 112 impacts or encounters the vertical discontinuity or longitudinal gap discontinuity 200, 300 (shown in FIGS. 2 and 3) in the rail 106, an increased impact force 400 may be imparted on the rail 106.

The impact force 400 represents an increase in the force on the rail 106 (shown in FIG. 1) as applied by the wheel 112 (shown in FIG. 1) without the wheel impact reduction systems 500, 600 (shown in FIGS. 5 and 6) applying the correction force 424 to reduce the impact force 400. As shown in FIG. 4, the impact force 400 may be represented as a waveform comprising two waveform segments 410, 412 having different frequencies. The waveform segments 410, 412 include a high frequency segment 410 and a low frequency segment 412 in the illustrated example. The high frequency segment 410 is referred to herein as a P1 force that is imparted on the rail 106 and the low frequency segment 412 is referred to herein as a P2 force that is imparted on the rail 106. The low frequency segment 412 may have a lower frequency than the high frequency segment 410 in that the low frequency segment 412 extends over a longer time period than the high frequency segment 410. The intersection of the horizontal and vertical axes 404, 406 may represent the beginning of the impact of the wheel 112 on the vertical and/or horizontal rail discontinuity 200, 300 (shown in FIGS. 2 and 3). The high frequency segment 410 begins at the impact and lasts for an initial time period 414. The low frequency segment 412 begins at a later time and lasts for a subsequent time period 416 that follows the initial time period 414. As shown in FIG. 4, the high and low frequency segments 410, 412 eventually terminate and the impact force 400 returns to the baseline force 408.

As described below, one or more embodiments set forth herein provide wheel impact reduction systems 500, 600 (shown in FIGS. 5 and 6) that reduce the impact force 400 imparted by the wheel 112 (shown in FIG. 1) on the rail 106 (shown in FIG. 1). The wheel impact reduction systems 500, 600 may reduce the impact force 400 to the reduced impact force 402 by applying the correction force 424 to the wheel 112. The correction force 424 may be applied over or during the P2 force, or the low frequency waveform segment 412. As shown in FIG. 4, the correction force 424 reduces the P2 force of the wheel 112 to the reduced impact force 402. Reducing the impact force imparted by the wheel 112 on the rail 106 may reduce damage to the rail 106 and prolong the useful life of the rail 106.

FIG. 5 is a diagram of the wheel impact reduction system 500 in accordance with one embodiment. The system 500 includes a sensor 502 that is communicatively coupled with a control module 504. The control module 504 is communicatively coupled with a force reduction assembly 506. The force reduction assembly 506 is joined with one or more of the wheels 112 of the rail vehicle 100. For example, the force reduction assembly 506 may be interconnected with one of the wheels 112 and/or an axle 514 that laterally joins wheels 112 with each other.

The sensor 502 detects discontinuities 508, 510, such as vertical and/or longitudinal discontinuities 200, 300 (shown in FIGS. 2 and 3) in the rail 106. In the illustrated embodiment, the sensor 502 is located forward or upstream of the wheel 112 along the direction of travel 208 of the rail vehicle 100. For example, the sensor 502 may be joined to or hung from the rail vehicle 100 above the rail 106 and ahead of the wheel 112. Alternatively, the sensor 502 may be coupled with another wheel 112 or with the axle 514 of another, different wheel 112. For example, the system 500 may be configured to reduce the impact force 400 imparted by a rearward wheel 112 with the sensor 502 joined with a forward wheel 112, with the forward wheel 112 being located upstream or forward of the rearward wheel 112 along the direction of travel 208. While only a single sensor 502 is shown in FIG. 5, multiple sensors 502 may be provided. For example, in tracks having two or more rails 106 along which the wheels 112 travel, the system 500 may have at least one sensor 502 for each rail 106.

The sensor 502 may use one or more of a variety of techniques or technologies to sense discontinuities 508, 510 in the rail 106. By way of non-limiting examples only, the sensor 502 may be an optical sensor that detects the discontinuities 200, 300 (shown in FIGS. 2 and 3) based on the relative positions of the segments 202, 204 (or 302, 304 shown in FIG. 3) of the rail 106. For example, in order to sense vertical discontinuities 200, the sensor 502 may optically detect changes in the positions of the upper surfaces 206 (shown in FIG. 2) of the adjacent sections 202, 204 of the rail 106. In order to sense longitudinal discontinuities 300, the sensor 502 optically detects gaps between the opposing ends 306, 308 (shown in FIG. 3) of adjacent sections 302, 304 of the rail 106. Alternatively, the sensor 502 may be a different type of sensor, such as a capacitive sensor, a position sensor, a magnetic sensor, a contact sensor, an acoustic or sonic sensor, and the like, that is capable of detecting discontinuities 200, 300 in the rail 106.

In one embodiment, the sensor 502 detects discontinuities 200, 300 (shown in FIGS. 2 and 3) by monitoring the electric current supplied to and/or the speed of a fraction motor 110. For example, the sensor 502 may monitor the current supplied to and/or the speed of a traction motor 110 that is joined with a forward wheel 112 in order to determine if the current and/or speed changes. A change in the current and/or speed of a traction motor 110 joined to a forward wheel 112 may indicate that the forward wheel 112 has encountered a discontinuity 200 or 300. For example, the forward wheel 112 may slow down and/or demand less current when the forward wheel 112 strikes a discontinuity 200 or 300. The change in current and/or speed may be used by the sensor 502 to identify the discontinuity for a trailing or rearward wheel 112. For example, the change in current and/or speed for a leading or forward wheel 112 may be used to identify a discontinuity for a trailing or rearward wheel 112 that has not yet reached the discontinuity 200, 300.

Alternatively, the sensor 502 is a motion sensor that detects movement of a forward wheel 112 in order to sense a discontinuity 200, 300 (shown in FIGS. 2 and 3) for a rearward wheel 112. The sensor 502 may be joined to the forward wheel 112 or to an axle 514 of the forward wheel 112. When the forward wheel 112 encounters a rail discontinuity 200 and/or 300, the forward wheel 112 may abruptly move in one or more directions. For example, the sensor 502 may detect movement of the forward wheel 112 by a distance in one or more directions that exceeds a predetermined threshold distance. This movement may be sensed as one or more of the discontinuities 200, 300 prior to the rearward wheel 112 encountering the discontinuity 200, 300.

In another embodiment, the sensor 502 may be a motion sensor that detects movement of the wheel 112 in order to sense when the same wheel 112 encounters a discontinuity 200, 300 (shown in FIGS. 2 and 3). For example, as opposed to sensing a discontinuity 200 and/or 300 for a different wheel, the sensor 502 may be coupled with the same wheel 112 for which the sensor 502 detects discontinuities 200, 200. The sensor 502 may be joined to the wheel 112 or to an axle 514 of the wheel 112. When the wheel 112 encounters a rail discontinuity 200 and/or 300, the sensor 502 may detect movement of the wheel 112 as the wheel 112 strikes the discontinuity 200, 300.

The sensor 502 communicates detection of one or more discontinuities 508, 510 in the rail 106 to the control module 504. The sensor 502 may be communicatively coupled with the control module 504 by way of one or more wired and/or wireless connections. The sensor 502 communicates an identification of the discontinuity 508 and/or 510 to the control module 504. For example, the sensor 502 may communicate a detected condition of the discontinuity 508 and/or 510 to the control module 504 that indicates detection of the discontinuity 508 and/or 510. The control module 504 may be embodied in or include a logic device, such as a computer processor, microprocessor, controller, microcontroller, and the like. The control module 504 may include a memory 520. The memory 520 may be tangible and non-transitory computer readable storage medium, such as a computer disc drive, flash memory, and the like, that includes instructions. The instructions may be software, such as object code, that communicates with the sensor 502, calculates one or more parameters based on the identification of discontinuities 508, 510 by the sensor 502, forms and/or communicates instructions to the force reduction assembly 506, and the like. For example, the control module 504 may include instructions that direct the sensor 502 to periodically poll or check the rail 106 for discontinuities 200 and/or 300 (shown in FIGS. 2 and 3).

The control module 504 is communicatively coupled with the force reduction assembly 506 by one or more wired and/or wireless connections. In one embodiment, the control module 504 is a torque control module that drives one or more of the traction motors 110 to control the speed of the rail vehicle 100. The control module 504 instructs the force reduction assembly 506 to reduce the impact force 400 imparted on the rail 106 by the wheel 112 based on the detection of one or more discontinuities 508, 510 by the sensor 502. The force reduction assembly 506 reduces the impact force 400 imparted on the rail 106 by introducing the correction force 424 on the wheel 112. In the illustrated embodiment, the correction force 424 is a vertical component of a force applied to the wheel 112 in a direction oriented opposite to the direction in which the impact force 400 is applied to the rail 106. The correction force 424 may be applied in one or more other directions than the direction shown in FIG. 5 in order to reduce the impact force 400. For example, the correction force 424 may be the vertical component of a force that is applied to the wheel 112 in a direction that is transverse or obliquely oriented with respect to the impact force 400.

The force reduction assembly 506 may apply the correction force 424 at approximately the same time that the wheel 112 encounters the discontinuity 508, 510. For example, based on the distance between the sensor 502 and the wheel 112, the speed of the rail vehicle 100, and the like, the force reduction assembly 506 may apply the correction force 424 at the same time or at approximately the same time that the wheel 112 strikes or passes over the discontinuity 508 or 510. In another embodiment, the force reduction assembly 506 may apply the correction force 424 over or during the low frequency waveform segment 412 (shown in FIG. 4) of the impact force 400.

In the illustrated embodiment, the force reduction assembly 506 includes the traction motor 110 that is coupled with the wheel 112. The fraction motor 110 is joined with the wheel 112 to propel the rail vehicle 100 along the rails 106 and to reduce the impact force 400 imparted by the wheel 112. The traction motor 110 is connected with the axle 514 of the wheel 112 and is coupled with the wheel 112 by a pinion gear 516. For example, in one embodiment, the traction motor 110 is hung or coupled to the axle 514 of the wheel 112 as opposed to being hung from a frame (not shown) of the rail vehicle 100. The traction motor 110 may be coupled with the wheel 112 by the pinion gear 516 and a complementary bull gear 522. The traction motor 110 is joined with the pinion gear 516, and the pinion gear 516 meshes with or otherwise engages the bull bear 522. The bull gear 522 is joined with the wheel 112. The traction motor 110 rotates the pinion gear 516 to cause complementary rotation of the bull gear 522. Rotation of the bull gear 522 causes rotation of the wheel 112. Alternatively, more than one pinion gear 516 may couple the traction motor 110 to the wheel 112.

When the control module 504 receives an identification of the discontinuity 508, 510, the control module 504 may form instructions that are communicated to the force reduction assembly 506. The instructions may direct the traction motor 110 to apply a torque impulse to the pinion gear 516. Application of the torque impulse to the pinion gear 516 causes the pinion gear 516 to rotate in a direction 518. As the pinion gear 516 rotates in the direction 518, the bull gear 522 is rotated in an opposite direction 524. The engagement between the pinion gear 516 and the bull gear 522 also causes the rotation of the pinion gear 516 in the direction 518 to impart a vertical force on the bull gear 516. For example, teeth of the pinion gear 516 may mesh with teeth of the bull gear 522. As the teeth of the pinion gear 516 move in the direction 518, the teeth of the pinion gear 516 that engage the teeth of the bull gear 522 move in an upward direction away from the rail 106. The upward movement of the teeth of the pinion gear 516 applies a force on the teeth of the bull gear 522 that is oriented in one or more directions away from the rail 106. The correction force 424 may be the vertical component of the force applied by the teeth of the pinion gear 516 on the teeth of the bull gear 522. Thus, in an embodiment, if the pinion gear 516 is rotating at a steady state speed for movement of the vehicle 100 along a rail, the correction force 424 may be generated by momentarily increasing or “spiking” the rotational speed of the pinion gear 516 above the steady state speed, and then returning the pinion gear 516 to the steady state speed. Such momentary increases in speed may be generated by applying a current pulse to the traction motor 110 driving the pinion gear 516, where the waveform of the current pulse is proportional to or otherwise based on characteristics of the detected discontinuity (e.g., magnitude, type).

Application of the correction force 424 to the wheel 112 reduces the impact force 400 that the wheel 112 imparts on the rail 106. With reference to the discussion of the impact forces 400, 402 shown in FIG. 4, the application of the correction force 424 may decrease the forces that the wheel 112 applies to the rail 106. As shown in FIG. 4, the reduced impact force 402 is similar to the impact force 400 with a reduced low frequency segment 412. For example, the reduced impact force 402 has a smaller P2 force than the impact force 400. In order to lessen the damage done to the rail 106 by the wheel 112, the correction force 424 lowers the low frequency segment 412 of the impact force 400. In accordance with one embodiment, reducing the strength of the low frequency segment 412 of the impact force 400 reduces damage to the rail 106 that is caused by the wheel 112 striking the rail discontinuities 200, 300 (shown in FIGS. 2 and 3). For example, the reduced impact force 402 and the reduced low frequency segment 412 of the impact force 402 may cause less damage to the rail 106 than the low frequency segment 412 of the impact force 400.

The time period over which the correction force 424 is applied to the wheel 112 may be based on the size of the discontinuity 200, 300 (shown in FIGS. 2 and 3). For example, if the discontinuity 508 is a relatively large longitudinal discontinuity 300, then the control module 504 may direct the traction motor 110 to apply the torque impulse to the wheel 112 for a longer time period than for a smaller longitudinal discontinuity 300. The control module 504 may base the duration over which the correction force 424 is applied by the traction motor 110 on the size of the discontinuity 200, 300 (shown in FIGS. 2 and 3) and/or the speed of the rail vehicle 100. For example, for larger longitudinal discontinuities 300 and/or slower moving rail vehicles 100, the control module 504 may increase the time period over which the correction force 424 is applied to the wheel 112. Conversely, in another example, for smaller longitudinal discontinuities 300 and/or faster moving rail vehicles 100, the control module 504 may decrease the time period over which the correction force 424 is applied to the wheel 112.

The strength or magnitude of the correction force 424 may be based on the size of the discontinuity 508 and/or 510. For example, if the discontinuity 508 is a relatively large vertical discontinuity 200 (shown in FIG. 2), then the control module 504 may direct the traction motor 110 to apply a relatively large correction force 424 on the wheel 112 relative to smaller vertical discontinuities 200. Conversely, in another example, for smaller vertical discontinuities 200, the control module 504 may decrease the strength or magnitude of the correction force 424.

In one embodiment, the control module 504 is communicatively coupled with a plurality of the wheels 112. The control module 504 may adjust a torque impulse that is applied to one wheel 112 based on the torque impulse applied to another wheel 112 due to detection of a discontinuity 508, 510. For example, when a discontinuity 508 and/or 510 is sensed in front of a first wheel 112 and the control module 504 directs the traction motor 110 of the first wheel 112 to apply a torque impulse to the first wheel 112 in response to the discontinuity 508, 510, the control module 504 may direct the traction motor 110 of the second wheel 112 to apply an opposite torque impulse, or a torque impulse in the opposite direction, to the second wheel 112. Applying the torque impulses in opposite directions to the first wheel 112 that is approaching the discontinuity 508 and/or 510 and to the second wheel 112 that is spaced apart from the discontinuity 508 and/or 510 may cause the torque impulses to cancel each other out such that the net tractive effort applied by the traction motors 110 is approximately zero.

In another embodiment, the control module 504 uses predetermined locations of discontinuities 508 and/or 510 in order to determine when to apply corrective forces 424 to the wheels 112. For example, the memory 520 of the control module 504 may include a list or map of previously sensed or identified discontinuities 508, 510 along the trip that the rail vehicle 100 is traveling. The list or map may include the locations along the rails 106 where the rails 106 have been damaged. For example, the list or map may include locations where one or more rails 106 have been separated from the ties or sleepers of the rail bed.

As the rail vehicle 100 travels along the trip, the control module 504 refers to the list or map of discontinuities 508, 510 and/or locations of rail damage and compares the known locations of the discontinuities 508, 510 and/or damage to the current location and/or speed of the rail vehicle 100. When the rail vehicle 100 encounters a location of a discontinuity 508, 510 and/or damage that is obtained from the memory 520, the force reduction assembly 506 applies the corrective force 424, as described above. The control module 504 may direct the traction motors 110 to slow down. For example, the control module 504 may direct the traction motors 110 to reduce the speed of the rail vehicle 100 when the location of a damaged rail 106 is encountered. The control module 504 may include a GPS device or other device that determines the current location of the rail vehicle 100. The predetermined locations of the discontinuities 508, 510 and/or rail damage may be downloaded to the memory 520 via a wired or wireless communication link with the control module 504. For example, the control module 504 may have an I/O port configured to couple with a connector and/or a wireless receiver to communicate the locations of the discontinuities 508, 510 and/or damage.

The control module 504 may generate a list of locations of sensed discontinuities 508, 510 for later use by the rail vehicle 100 or another rail vehicle 100. For example, during a trip, the control module 504 may store locations of the discontinuities 508, 510 when the discontinuities 508, 510 are identified by the sensor 502. The locations may be stored in the memory 520. As described above, the locations may be used by the rail vehicle 100 to determine when to apply the corrective force 424. The control module 504 may communicate the locations to a central database or repository, such as a computer server located at a rail station. The locations may then be downloaded to the memories 520 of other rail vehicles 100 so that the other rail vehicles 100 may use the previously determined locations of the discontinuities 508, 510 to determine when to apply corrective forces 424 to the wheels 112.

FIG. 6 is a diagram of the wheel impact reduction system 600 in accordance with another embodiment. The system 600 includes a sensor 602 and a control module 604 that may be similar to the sensor 502 (shown in FIG. 5) and the control module 504 (shown in FIG. 5) of the wheel impact reduction system 500 (shown in FIG. 5). The control module 604 is communicatively coupled with a force reduction assembly 606. The force reduction assembly 606 is joined with one or more of the wheels 112 of the rail vehicle 100. For example, the force reduction assembly 606 may be interconnected with one of the wheels 112 and/or an axle 514 (shown in FIG. 5) that joins wheels 112 with each other. In the illustrated embodiment, the force reduction assembly 606 is joined with one of the wheels 112.

As described above in connection with the sensor 502 (shown in FIG. 5), the sensor 602 detects discontinuities 608, 610, such as vertical and/or longitudinal discontinuities 200, 300 (shown in FIGS. 2 and 3) in the rail 106. The sensor 602 communicates detection of one or more discontinuities 608, 610 in the rail 106 to the control module 604. The sensor 602 communicates an identification of a discontinuity 608, 610 to the control module 604. Similar to the control module 504 (shown in FIG. 5), the control module 604 instructs the force reduction assembly 606 to reduce the impact force 400 imparted on the rail 106 by the wheel 112 based on the detection of one or more discontinuities 608, 610 by the sensor 602. The force reduction assembly 606 reduces the impact force 400 imparted on the rail 106 by actuating the wheel 112 and introducing the correction force 424 on the wheel 112. The correction force 424 may be a vertical component of a force applied to the wheel 112 in a direction oriented opposite to the direction in which the impact force 400 is applied to the rail 106. The correction force 424 may be applied in one or more other directions than the direction shown in FIG. 6 in order to reduce the impact force 400. For example, the correction force 424 may be the vertical component of a force that is applied to the wheel 112 by the force reduction assembly 606 in a direction that is transverse or obliquely oriented with respect to the impact force 400. In the illustrated embodiment, the force reduction assembly 606 applies the correction force 424 by moving the wheel 112 away from the rail 106. For example, the force reduction assembly 606 may move the wheel 112 toward the rail vehicle 100 and in a direction that is oriented opposite of the rail 106.

In the illustrated embodiment, the force reduction assembly 606 includes an actuator 614 that is coupled with the wheel 112. The actuator 614 is a device that may apply the correction force 424 by moving the wheel 112 in a direction away from the rail 106 based on instructions from the control module 604. For example, the actuator 614 may be one or more of a linear actuator, a pneumatic actuator, a hydraulic actuator, an electric actuator, an electro-magnetic actuator, a high pressure gas actuator, a mechanical actuator, and the like, that moves the wheel 112 away from the rail 106. While the wheel 112 may remain in contact with the rail 106, the lifting action of the actuator 614 on the wheel 112 applies the correction force 424 to the wheel 112 and may lessen the impact force 400 by the correction force 424.

In operation, when the control module 604 receives the notice of the discontinuity 608 and/or 610, the control module 604 may form instructions that are communicated to the force reduction assembly 606. As described above, the force reduction assembly 606 causes the actuator 614 to apply the correction force 424 to the wheel 112 in order to reduce the impact force 400.

Similar to as described above in connection with the impact reduction system 500 (shown in FIG. 5), the time period over which the correction force 424 is applied to the wheel 112 by the actuator 614 may be based on the size of the discontinuity 608 and/or 610. For example, as the size of longitudinal discontinuities 300 (shown in FIG. 3) increases, the actuator 614 may apply the correction force 424 for longer periods of time. The strength or magnitude of the correction force 424 may be based on the size of the discontinuity 608 and/or 610. For example, as the size of vertical discontinuities 200 (shown in FIG. 2) increases, the actuator 614 may apply greater reducing forces 424. The actuator 614 may increase the correction force 424 by moving the wheel 112 a greater direction toward the rail vehicle 100 and farther from the rail 106.

In one embodiment, the control module 604 is communicatively coupled with a plurality of the wheels 112. As described above in connection with the control module 504 of FIG. 5, the control module 604 may adjust the torque impulses that are applied to two or more of the wheels 112 when a discontinuity 608 and/or 610 is discovered in order to approximately cancel out the net tractive effort of the rail vehicle 100. In another embodiment, the control module 604 uses predetermined locations of discontinuities 608, 610 and/or locations of rail damage in order to determine when to apply corrective forces 424 to the wheels 112. For example, the control module 604 may include a memory 620 that is similar to the memory 520 (shown in FIG. 5). The memory 620 may store a list or map of previously sensed or identified discontinuities 608, 610 and/or locations of rail damage along the trip that the rail vehicle 100 is traveling. As the rail vehicle 100 travels along the trip, the control module 604 refers to the list or map of discontinuities 608, 610 and/or locations of rail damage and compares the known locations of the discontinuities 608, 610 and/or damage to the current location and/or speed of the rail vehicle 100. As described above, the control module 604 may determine when to apply the corrective force 424 and/or control the speed of the rail vehicle 100 based on this list or map.

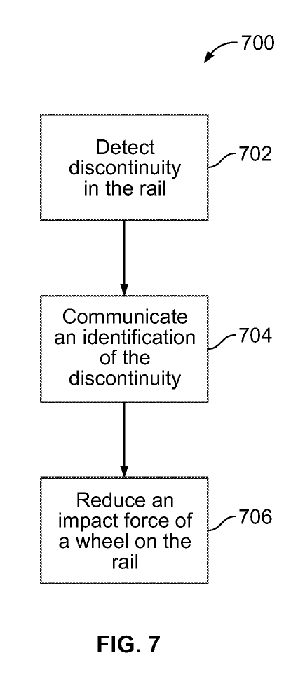

FIG. 7 is a flowchart of a method 700 for reducing wheel impact forces imparted on a rail by a wheel of a rail vehicle in accordance with one embodiment. At 702, a discontinuity in the rail is detected. For example, a sensor 502, 602 (shown in FIGS. 5 and 6) may detect a presence of a vertical and/or longitudinal discontinuity 200, 300 (shown in FIGS. 2 and 3) in the rail 106 (shown in FIG. 1) upstream of the wheel 112 (shown in FIG. 1) along the direction of travel 208 (shown in FIG. 2) of the rail vehicle 100 (shown in FIG. 1).

At 704, an identification of the discontinuity in the rail is communicated to a control module, such as the control module 504 or 604 (shown in FIGS. 5 and 6). Based on the identification of the discontinuity that is detected, the control module determines when to apply a correction force, such as the correction force 424, to the wheel. For example, the control module 504, 604 may calculate when to apply the correction force 424 based on the speed of the rail vehicle 100, the distance between the wheel 112 and the sensor 502, 602 that detected the discontinuity 200 and/or 300, and the like. In one embodiment, the control module 504, 604 determines how long to apply the correction force 424 based on the size of the discontinuity 200 and/or 300 detected by the sensor 502, 602. The control module 504, 604 may vary the magnitude or strength of the correction force 424 based on the size of the discontinuity 200 and/or 300.

At 706, the correction force is applied to the wheel 112 (shown in FIG. 1) to reduce the impact force that the wheel 112 imparts on the rail 106 (shown in FIG. 1). For example, the force reduction assembly 506, 606 (shown in FIGS. 5 and 6) may receive instructions from the control module 504, 604 (shown in FIGS. 5 and 6) that direct the force reduction assembly 506, 606 to apply the correction force 424 (shown in FIG. 4) on the wheel 112. The instructions may direct the force reduction assembly 506, 606 when to apply the correction force 424, the duration that the correction force 424 is to be applied to the wheel 112, and/or the strength or magnitude of the correction force 424.

In an embodiment, a discontinuity in a rail may include an irregularity in an upper surface 206 of the rail, e.g., a bump, divot, or the like. In another embodiment, a discontinuity in a rail may include a foreign object on the rail.

In another embodiment, the sensor 502, 602 comprises and/or is associated with a non-traction, non-load bearing roller or wheel that is deployed forward (upstream) of a traction wheel 112 to which a correction force is potentially applied (i.e., there is a force reduction assembly 506 joined to the wheel 112). The non-traction, non-load bearing roller or wheel is aligned to travel on the rail 106, but does not provide tractive force and does not help to carry or support the vehicle on the rail. Instead, the non-traction, non-load bearing roller or wheel is provided for sensing purposes. In operation, as the vehicle moves along the rail 106, the non-traction, non-load bearing roller or wheel contacts and tracks along the rail 106, ahead of the traction wheel 112. When the non-traction, non-load bearing roller or wheel encounters a discontinuity in the rail 106, it moves up or down in response. (The non-traction, non-load bearing roller or wheel may be deployed at the end of a spring-biased support arm, connected to the vehicle carriage, which allows the non-traction, non-load bearing roller or wheel to move vertically but stay in contact with the rail.) The assembly of the non-traction, non-load bearing roller or wheel includes a motion sensor, which senses vertical motion of the non-traction, non-load bearing roller or wheel and translates the sensed motion into an electrical signal for providing to the control module. In an embodiment, the non-traction, non-load bearing roller or wheel includes a polymer or polymer composite tread, i.e., akin to an automobile wheel, to reduce weight (as opposed to a metal only wheel) and improve tracking of the wheel along the rail.

In another embodiment, the sensor 502, 602 comprises a brush assembly. The brush assembly comprises a support arm attached to the vehicle carriage, a brush array attached to the distal end of the arm (away from the carriage), and an electrical line(s) communicatively connecting the brush array to the control module. The brush array includes a plurality of elongate brush fibers (e.g., carbon composite brush fibers), and a plurality of sensors each associated with one of the brush fibers. In other words, for each brush fiber, there is a respective sensor. The sensors may be embedded in a base that supports and holds the brush fibers. Each sensor is configured to detect movement of its associated brush fiber, and to generate an electrical signal responsive to and indicative of the brush fiber's movement. In operation, the brush assembly is deployed so that the brush fibers of the brush array contact the rail 106. It may be the case that the brush fibers are bent back for trailing along the rail. When the vehicle moves along the rail, deflections or other movement of the brush fibers are tracked and analyzed for determining if a rail discontinuity has been encountered. For example, if the brush fibers contact a discontinuity 610 as shown in FIG. 6, they may deflect back and/or upwards. This movement is registered by the brush array sensors, and provided to the control module. If the movement is of sufficient magnitude (e.g., above a threshold), then a correction force is applied to a rearward wheel 112 as described above. In the case of a longitudinal discontinuity 300, the brush fibers may be biased/positioned so that upon encountering the longitudinal discontinuity 300, they flex downwards into the space of the longitudinal discontinuity 300, thereby providing a useful movement signal that can be analyzed and assessed by the control module for assessing the longitudinal discontinuity 300.

In an embodiment, sensors 502, 602 that do not utilize contact with the rail for generating sensor data of rail discontinuities may be referred to as “non-contact” sensors. Sensors 502, 602 that do utilize contact with the rail for generating sensor data of rail discontinuities may be referred to as “contact” sensors. Examples of contact sensors include the aforementioned brush assembly, and sensors that sense wheel movement.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. While the dimensions and types of materials described herein are intended to define the parameters of the disclosed subject matter, they are by no means limiting and are exemplary embodiments. Many other embodiments will be apparent to those of skill in the art upon reviewing the above description. The scope of the subject matter described herein should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

This written description uses examples to disclose several embodiments of the above subject matter, including the best mode, and also to enable any person skilled in the art to practice the embodiments of subject matter, including making and using any devices or systems and performing any incorporated methods. The patentable scope of the subject matter described herein is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A wheel impact reduction system for a rail vehicle, the system comprising:
a sensor configured to detect a discontinuity in a rail located upstream of a wheel of the rail vehicle in a direction of travel of the rail vehicle;
a control module communicatively coupled with the sensor, the control module determining whether to apply a correction force to the wheel based on the discontinuity detected by the sensor; and
a force reduction assembly configured to be joined to the wheel of the rail vehicle and communicatively coupled with the control module, the force reduction assembly reducing a wheel impact force imparted on the rail by the wheel by applying the correction force to the wheel.

2. The wheel impact reduction system of claim 1, wherein the force reduction assembly reduces the wheel impact force by applying the correction force to the wheel in a direction oriented transverse to the rail.

3. The wheel impact reduction system of claim 1, wherein the force reduction assembly includes a traction motor coupled with the wheel, the traction motor reducing the wheel impact force by changing a torque applied to the wheel based on the discontinuity detected by the sensor.

4. The wheel impact reduction system of claim 3, wherein the wheel is a first wheel and the force reduction assembly additionally changes a torque applied to a second wheel based on the discontinuity detected by the sensor.

5. The wheel impact reduction system of claim 1, wherein the force reduction assembly includes an actuator that lifts the wheel in a direction away from the rail based on the discontinuity detected by the sensor.

6. The wheel impact reduction system of claim 5, wherein the actuator is at least one of a linear actuator, a pneumatic actuator, a hydraulic actuator, an electric actuator, an electro-magnetic actuator, a high pressure gas actuator, or a mechanical actuator.

7. The wheel impact reduction system of claim 1, wherein the force reduction assembly reduces a low frequency segment of the wheel impact force when the wheel strikes the discontinuity in the rail.

8. The wheel impact reduction system of claim 1, wherein the wheel is a rearward wheel and further comprising a forward wheel disposed upstream of the rearward wheel along the direction of travel, the sensor interconnected with the forward wheel and detecting the discontinuity based on at least one of movement of the forward wheel, electric current supplied to a traction motor of the forward wheel, or speed of the traction motor of the forward wheel.

9. The wheel impact reduction system of claim 1, wherein the sensor detects the discontinuity in the rail as at least one of a longitudinal gap between adjacent sections of the rail or a vertical change in upper surfaces of the adjacent sections of the rail.

10. The wheel impact reduction system of claim 1, wherein the control module directs the force reduction assembly to apply the correction force to the wheel that is based on a size of the discontinuity detected by the sensor.

11. The wheel impact reduction system of claim 1, wherein the sensor includes at least one of an optical sensor, a capacitive sensor, a position sensor, a magnetic sensor, or an acoustic sensor.

12. A method for reducing a wheel impact force imparted by a wheel of a rail vehicle on a rail, the method comprising:
detecting a discontinuity in the rail located upstream of the wheel in a direction of travel of the rail vehicle;
communicating an identification of the discontinuity to a force reduction assembly interconnected with the wheel; and
reducing the wheel impact force imparted on the rail by the wheel based on the discontinuity detected by the sensor by applying a correction force to the wheel using the force reduction assembly.

13. The method of claim 12, wherein reducing the wheel impact force comprises applying the correction force to the wheel in a direction oriented transverse to the rail.

14. The method of claim 12, wherein reducing the wheel impact force comprises changing a torque applied to the wheel by a traction motor.

15. The method of claim 12, wherein reducing the wheel impact force comprises moving the wheel in a direction oriented away from the rail.

16. The method of claim 12, wherein reducing the wheel impact force comprises reducing a low frequency segment of the wheel impact force when the wheel strikes the discontinuity in the rail.

17. The method of claim 12, wherein detecting the discontinuity comprises sensing the discontinuity as at least one of a longitudinal gap in the rail or a vertical change in upper surfaces of adjacent sections of the rail.

18. A tangible and non-transitory computer readable storage medium for a rail vehicle having a sensor and a force reduction assembly joined with a wheel of the rail vehicle, the computer readable storage medium comprising:
instructions to direct the sensor to detect a discontinuity in a rail located upstream from the wheel along a direction of travel of the rail vehicle; and
instructions to direct the force reduction assembly to reduce a wheel impact force imparted on the rail by the wheel based on the discontinuity detected by the sensor by applying a correction force to the wheel.

19. The computer readable storage medium of claim 18, wherein the instructions direct the force reduction assembly to apply the correction force to the wheel in a direction oriented transverse to the rail.

20. The computer readable storage medium of claim 18, wherein the instructions direct the force reduction assembly to at least one of change a torque applied to the wheel by a traction motor or move the wheel in a direction oriented away from the rail.
